(19) United States
(12) Patent Application Publication
(10) Pub. No.: US 2015/0006665 A1
(43) Pub. Date: Jan. 1, 2015

(54) STORAGE PROVISIONING NEGOTIATION

(71) Applicants: Vikram Krishnamurthy, Bangalore (IN); Anuradha P. Anantha, Bangalore (IN); Vasavi Sagi, Bangalore (IN); Surendra Sapra, Bangalore (IN)

(72) Inventors: Vikram Krishnamurthy, Bangalore (IN); Anuradha P. Anantha, Bangalore (IN); Vasavi Sagi, Bangalore (IN); Surendra Sapra, Bangalore (IN)

(21) Appl. No.: 14/373,452

(22) PCT Filed: Jan. 20, 2012
(86) PCT No.: PCT/IN2012/000049

§ 371 Date: Jul. 21, 2014

(51) Int. Cl. H04L 29/08; H04L 12/24

(52) U.S. Cl. CPC H04L 67/1097; H04L 41/5019
USPC 709/213

(57) ABSTRACT

In at least some examples, a computer system includes a processor and a storage device coupled to the processor. The storage device stores a storage provisioning negotiation module that, when executed, causes the processor to determine whether a received storage provisioning request is approved. If the received storage provisioning request is not approved, the storage provisioning negotiation module causes the processor to determine a set of alternative storage provisioning options based on predetermined negotiation rules.

### BACKGROUND

Storage Resource Management (SRM) refers to the process of optimizing the efficiency and speed with which available storage (drive) space is utilized in a storage area network (SAN). As data storage needs increases, companies are faced with rising hardware costs and also the increased costs of managing their storage. Storage professionals who are facing out-of control data growth rely on SRM technologies to help them navigate the storage environment. For example, SRM software utilities may identify underutilized capacity, identify old or non-critical data that could be moved to less-expensive storage, and predict future capacity requirements.

Some SRM software utilities provide SLA (Service Level Agreement) based automation of storage provisioning. However, if a provisioning request cannot be met, a user may have to manually figure out the next available alternative and submit one or more additional provisioning requests.

### BRIEF DESCRIPTION OF THE DRAWINGS

For a detailed description of illustrative examples, reference will now be made to the accompanying drawings in which:

FIG. 1 shows a computer system in accordance with various examples of the disclosure;

FIG. 2 shows a system in accordance with various examples of the disclosure;

FIG. 3 shows a storage access system in accordance with various examples of the disclosure;

FIG. 4 shows another storage access system in accordance with various examples of the disclosure;

FIG. 5 shows features of a storage access system management module in accordance with various examples of the disclosure;

FIG. 6 shows a method in accordance with various examples of the disclosure; and

FIG. 7 shows an illustrative computer system in accordance with various examples of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Also, the term “expander” is intended to mean a device capable of making connections between an array of endpoints. Also, the term “virtual storage unit” is intended to mean a presentation of one or more storage units having different characteristics than a related underlying physical storage unit. Also, the term “temporary connection” is intended to mean a connection that is not permanently hard-wired. Also, the term “subdivision” is intended to mean discrete portions of a component. For example, subdivisions of a physical storage unit refers to discrete portions of the physical storage unit. Also, the term “fabric” is intended to mean one or more switches (e.g., Fiber Channel Switches) that interconnect various ports and devices connected to the ports. Also, the term “service level agreement” is intended to mean a contractual agreement between providers and consumers of a service such as storage provisioning.

### DETAILED DESCRIPTION

Examples of the disclosure describe a method and system for automated best-effort storage provisioning. As disclosed herein, a received storage provisioning request may not be approved. In such case, at least one alternative storage provisioning option is determined as a next-best option. For example, predetermined negotiation rules may be applied to a database of storage pool data to determine alternative storage provisioning options. The predetermined negotiation rules may correspond to service level agreement (SLA) criteria such as storage her criteria, storage quantity criteria, and/or storage fabric criteria. If more than one alternative storage provisioning option is determined, a requester is able to select which of the alternative storage provisioning options is preferred.

Although not limited thereto, the storage provisioning techniques described herein may be implemented by a Storage Resource Management (SRM) software utility such as the “HP Storage Essentials” software suite. HP Storage Essentials enables SRM operations with high performance, availability and predictability. These SRM operations include storage discovery, capacity management, customized reporting, provisioning, business application and backup monitoring, and end-to-end performance management. The integrated portfolio of SRM management solutions increases staff efficiency, optimizes storage, automates and simplifies tasks, and replaces traditional, manually intensive tools such as spreadsheets, drawing programs and whiteboards used to manage storage assets.

HP Storage Essentials enables business service automation strategies, which allows enterprises to manage and automate their entire IT service including applications, servers, network and storage infrastructure. Heterogeneous SRM operations provided by HP Storage Essentials includes auto-discovery of physical arid virtual storage, infrastructure and server environments from a variety of vendors. Physical device discovery include hosts, host bus adapters (HBAs), switches, tape, physical servers, virtual servers, VMware, and storage systems. Auto-discovery of popular business applications including Oracle database, Microsoft SQL Server, Microsoft Exchange Server, Sybase database and InterSystems Cache’ database is supported. To enable end-to-end storage automation, HP Storage Essentials SRM operations are integrated with software utilities such as HP Operations Orchestration to automate manual and error-prone IT management processes including storage, and with software utilities such as HP Universal Configuration Management Database (UCMDB) to perform impact analysis modeling as well as reporting of requested changes to storage environments, automated change tracking, and compliance reporting for storage devices. HP Storage Essentials is compatible with industry standards such as Storage Management initiative Specification (SMI-S), Web-Based Enterprise Management (WBEM), Windows Management Instrumentation (WMI), JBoss and Java 2 Enterprise Edition (J2EE). In this manner, SRM operations are extensible and will support the demanding heterogeneous and multi-vendor IT environments that exist and that are being developed.

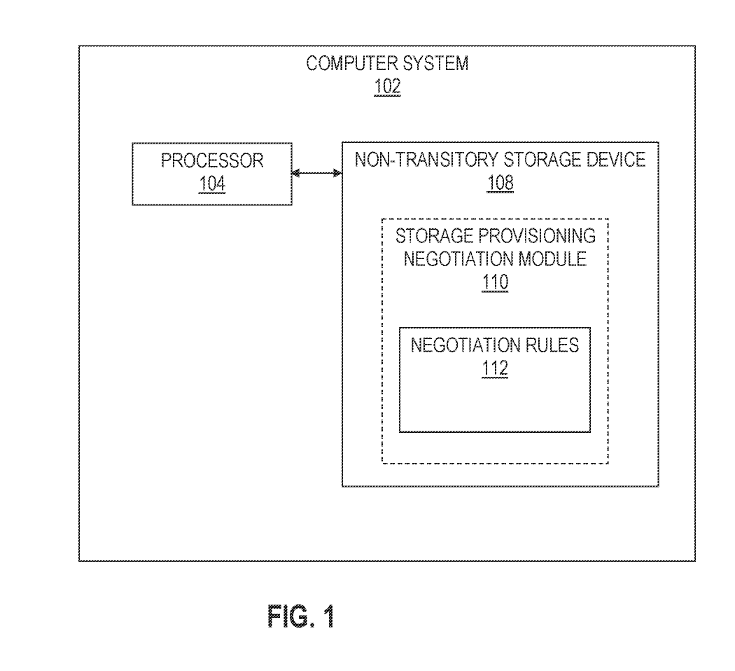

FIG. 1 shows a computer system 102 in accordance with various examples of the disclosure. As shown, the computer system 102 comprises a processor 104 coupled to a non-transitory storage device 108 that stores a storage provisioning negotiation module 110. When executed by the processor 104, the storage provisioning negotiation module 110 causes the processor 104 to determine whether a received storage provisioning request is approved. If the received storage provisioning request is not approved, the storage provisioning negotiation module 110 causes the processor to determine a set of alternative storage provisioning options based on predetermined negotiation rules 112.

For example, the predetermined negotiation rules 112 may comprise a rule that causes the processor 104 to identify whether an alternative storage provisioning option is available for a same storage tier value and for a lower storage quantity value compared to the received storage provisioning request. Additionally, the predetermined negotiation rules 112 may comprise a rule that causes the processor 104 to identify whether an alternative storage provisioning option is available for a lower storage tier value and for a same storage quantity value compared to the received storage provisioning request. Additionally, the predetermined negotiation rules 112 may comprise a rule that causes the processor 104 to identify whether an alternative storage provisioning option is available for a lower storage tier value and for a lower storage quantity value compared to the received storage provisioning request. Additionally, the predetermined negotiation rules 112 may comprise a rule that causes the processor 104 to identify whether an alternative storage provisioning option is available in another fabric compared to the received storage provisioning request. In at least some examples, the predetermined negotiation rules 112 cause the processor 104 to determine a prioritized set of alternative storage provisioning options according to a storage tier criteria, a storage quantity criteria, and a storage fabric criteria.

Once the alternative storage provisioning options are identified, the storage provisioning negotiation module 110 may cause processor 104 to present the identified options to a user for selection of one of the options. In some examples, the storage provisioning negotiation module 110 also causes the processor 104 to respond to a selection of an alternative storage provisioning option by initiating the selected storage provisioning subject to an automated clearance check performed after the selection. Additionally, or alternatively, the storage provisioning negotiation module 110 may cause the processor 104 to respond to a selection of an alternative storage provisioning option by initiating the selected storage provisioning subject to approval based on a manual clearance check performed by an administrator after the selection. If an alternative storage provisioning option is selected and is not approved due to a clearance check failure, the storage provisioning negotiation module 110 may cause the processor 104 to subsequently determine another set of alternative storage provisioning options based on the predetermined negotiation rules 112 for presentation to a user.

As an example, suppose a requester submits a storage provisioning request for a Platinum tier RAID 1 volume and the provisioning system cannot provision the request. In response, the disclosed examples determine the next best alternatives and trigger provisioning for a selected alternative.

In at least some examples, software utilities (e.g., HP Storage Essentials) are employed to collect all the data that is required to identify the next best alternatives. For example, post RAID calculation numbers for storage pool data and the definition of storage tiers may be collected. Also, the negotiation steps described herein can be built as a workflow using other software utilities (e.g., the HP Operations Orchestration tool).

For example, if a user requested a platinum tier RAID 1 volume of 1 terabyte (TB) and the provisioning request fails, a negotiation process (sometimes referred to herein as a service level agreement (SLA negotiation process) is triggered as a result. In at least some examples, the SLA negotiation process comprises the following steps. First, the N next-best options within the same fabric are identified according to predetermined negotiation rules or criteria. For example, rule_A of the predetermined negotiation rules may be applied to identify non-RAID 1 volumes of same capacity in the same tier. In some examples, such identification is possible by accessing storage pool data collected by SRM software utilities. The storage pool data may include metrics such as post-RAID calculations to identify the volume capacity of a specific RAID level that can be provisioned within a specified storage pool in arrays that are part of the selected storage tier.

Meanwhile, rule_B of the predetermined negotiation rules may be applied to identify RAID 1 volumes in the same tier and of less capacity than what the user requested. In some examples, the user can configure an acceptable limit for the new volume. For example, a user may identify that RAID 1 volumes, which are 80% the capacity of the requested volume (800 gigabytes (GB) in this case) are acceptable. Available storage volumes within the acceptable capacity range may be identified using post-RAID calculations.

Further, rule_C of the predetermined negotiation rules may be applied to identify RAID 1 volumes of same capacity in the next storage tier (e.g., identify RAID 1 volumes of 1 TB in a gold tier in this case) compared to the user request. Again, available storage volumes with the acceptable capacity range and her may be identified using post-RAID calculations.

Further, rule_D of the predetermined negotiation rules may be applied to identify RAID 1 volumes of lesser capacity in the next storage her (e.g., identify RAID 1 volumes of 800 GB in a gold tier in this case) compared to the user request. Again, available storage volumes with an acceptable capacity range (e.g., a range selected by a user) and tier may be identified using post-RAID calculations.

If a suitable alternative is not identified by applying rule_A to rule_D to storage pool data of the initial fabric, then the predetermined negotiation rules may repeat application of rule_A to rule_D for storage pool data of a secondary fabric. In such case, an additional step is needed to physically connect storage in the secondary fabric to the initial fabric for which the original request was made. The process of applying rule_A to rule_D for an initial fabric and for secondary fabrics may be managed by a first workflow that can be handed over to a second workflow to complete a configuration, where the first workflow resumes once the second workflow completes.

After N next-best options are identified, these options are presented to the user that submitted the original request. The user is thus able to select one of the options, after which it is provisioned. In some examples, the selected option may become unavailable or may not be approved by an administrator. In such case, the process of identifying N next-best options is repeated or the previous list is presented again until a selected option is approved.

The disclosed technique eliminates the administrative overhead involved in identifying the alternatives to a selected provisioning request. Further, by systematically analyzing and identifying the next-best alternatives to a selected provisioning request, the end user experience is greatly enhanced. Further, the overall time required to complete a provisioning job is substantially reduced. In some examples, the disclosed technique is applied to cloud service catalogs.

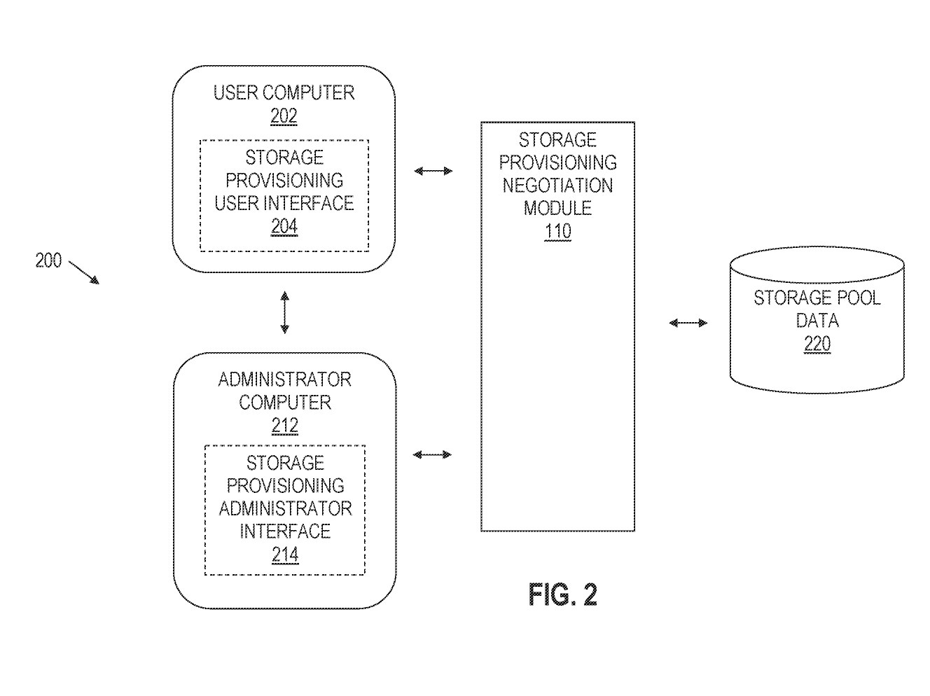

FIG. 2 shows a system 200 in accordance with various examples of the disclosure. As shown, the system 200 comprises a user computer 202 with a storage provisioning user interface 204 in communication with the storage provisioning negotiation module 110, which resides on a computer system as described for FIG. 1. The system 200 also comprises an administrator computer 212 with a storage provisioning administrator interface 214 in communication with the storage provisioning negotiation module 110. As described previously, the storage provisioning negotiation module 110 causes its executing processor to determine if a received storage provisioning request is approved or not. If not, the storage provisioning negotiation module 110 causes its executing processor to determine a set of alternative storage provisioning options based on predetermined negotiation rules as described herein.

To submit a storage provisioning request to the storage provisioning negotiation module 110, a user at the user computer 202 accesses the storage provisioning user interface 204, which comprises computer-readable instructions to present a user interface for submitting storage provisioning requests, for reviewing next-best options if a request cannot be met, and for selecting next-best options. As an example, to submit a storage provisioning request, displayed buttons may be clicked on by a mouse or via touch screen. Additionally or alternatively, text or other keystrokes may be entered. Regardless of the input format, the storage provisioning negotiation module 110 enables its executing processor to interpret (or receive an interpretation of) the storage provisioning request and determine whether the request can be met based on the storage pool data 220. If the request cannot be met, the storage provisioning negotiation module 110 causes its executing processor to analyze the storage pool data 220 to identify N next-best storage provisioning options based on the predetermined negotiation rules 112. The identified next-best options are then presented to the user via the storage provisioning user interface 204, whereby one of the options is selected by the user.

Upon selection, the storage provisioning negotiation module 110 causes its executing processor to carry out the selected option. Alternatively, the selected provisioning option is subject to an automated or manual clearance check. The automated clearance check may be performed by the storage provisioning negotiation module 110 causing its executing processor to verify with the storage pool data 220 that the selected storage provisioning is still available. Meanwhile, the manual clearance check may be performed by an administrator at the administrator computer 212 that is responsible for reviewing selected provisioning options via the storage provisioning administrator interface 214, which comprises computer-readable instructions for presenting storage provisioning information including clearance check information to an administrator. The administrator may decide against a selected provisioning option even if the storage pool data 220 indicates that the provisioning option is available. In response to a successful clearance check, the storage provisioning option is carried out. Alternatively, in response to a failed clearance check, the user at user computer 202 may be notified that the provisioning option cannot be met and/or another set of next-best provisioning options are presented for selection via the storage provisioning user interface 204.

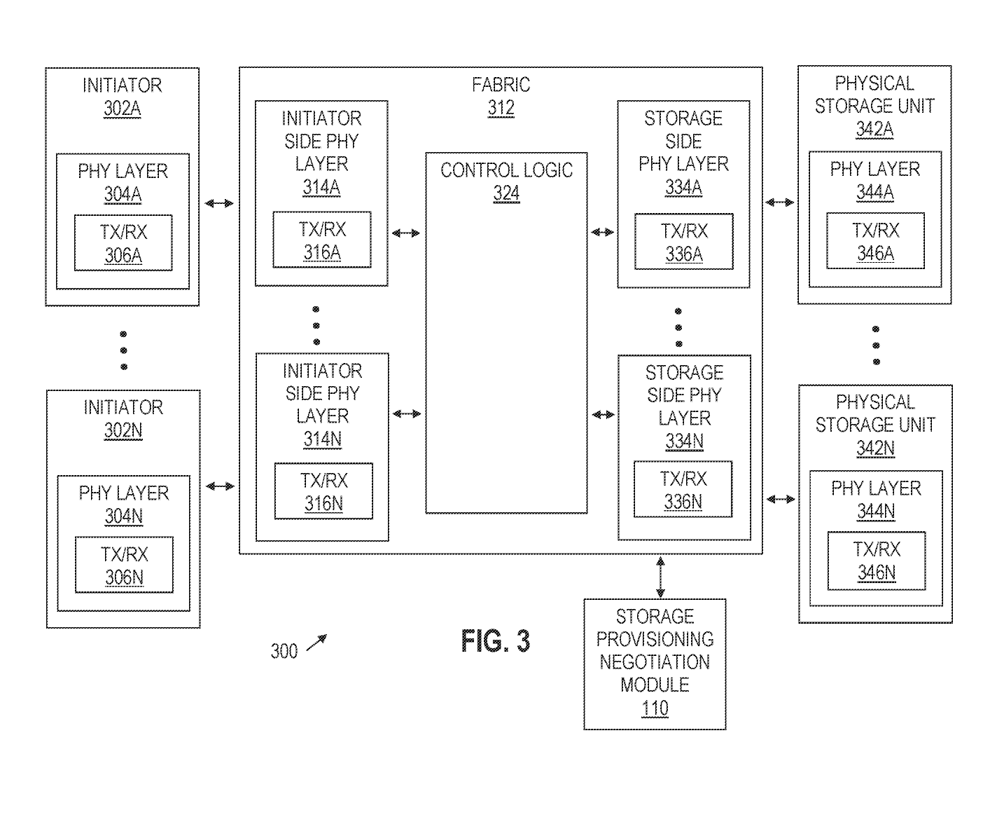

FIG. 3 shows a storage access system 300 in accordance with various examples of the disclosure. As shown, the storage access system 300 comprises a plurality of initiators 302A-302N in communication with a plurality of physical storage units 342A-342N via a fabric 312. The initiators 302A-302N may correspond to memory controllers, Fiber Channel Host Bus Adapters, or other devices that initiate a storage access request (e.g., to read or write data) directed to (targeting) at least one of the physical storage units 342A-342N. As shown, each of the initiators 302A-302N comprises a corresponding physical (PHY) layer 304A-304N and a transceiver (TX/RX) 306A-306N for transmitting storage access requests and receiving responses to storage access requests. Similarly, each of the physical storage units 342A-342N comprises a corresponding PHY layer 344A-344N and a transceiver (TX/RX) 346A-346N for receiving storage access requests and transmitting responses to storage access requests.

As shown, the fabric 312 comprises initiator side PHY layers 314A-314N with corresponding transceivers 316A-316N and storage side PHY layers 334A-334N with corresponding transceivers 336A-336N. In accordance with at least some examples, the number of storage side PHY layers 334A-334N is greater than the number of initiator side PHY layers 314A-314N in order to increase flexibility regarding the number of physical storage units that are accessible by at least some of the initiators 302A-302N of the storage access system 300. In other words, the fabric 312 may operate to expand the number of physical storage units that are accessible to each initiator 302A-302N by supporting temporary connections between an initiator and a physical storage unit. In this manner, increased flexibility in the storage access system 300 is provided without increasing the complexity of the initiators 302A-302N nor the physical storage units 342A-342N. The provisioning of storage to an initiator 302A via fabric 312 can be managed using the control logic 224.

In at least some examples, the fabric 312 is in communication with the storage provisioning negotiation module 110 described herein, which may reside on and is executed by a computer system. The computer system that executes the storage provisioning negotiation module 110 may be, for example, part of a storage area network (SAN) to which the various components of storage access system 300 also belong. In operation, the storage provisioning negotiation module 110 causes its executing processor to communicate with the fabric 312 to initiate storage provisioning, to update storage provisioning, to track storage provisioning, or to perform other operations as described herein. A database (not shown) with storage pool data 220 also may couple to the fabric 312 for storage of information relevant to the operations of the storage provisioning negotiation module 110.

Although the same variable “N” is used to describe the number of initiators, initiator side PHY layers, storage side PHY layers, and physical storage units, it should be understood that the variable “N” is intended to designate an arbitrary number. Thus, the number of initiators, the number of initiator side PHY layers, the number of storage side PHY layers, and the number of physical storage units could differ for different examples of the storage access system 300.

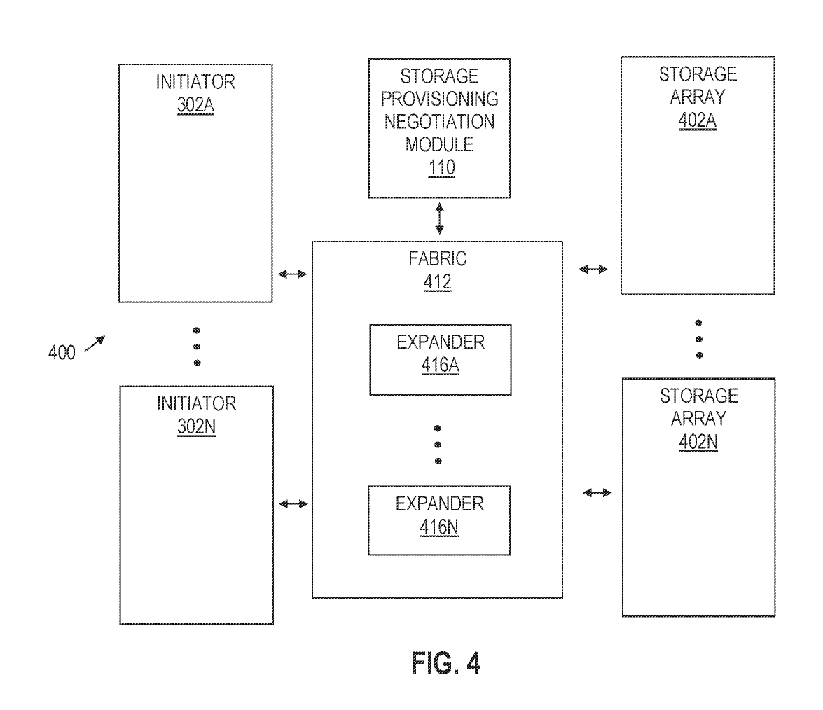

FIG. 4 shows another storage access system 400 in accordance with various examples of the disclosure. In the storage access system 400, a fabric 412 having a plurality of expanders 416A-416N is positioned between initiators 302A-302N and a plurality of storage arrays (or disk arrays) 402A-402N. Each of the storage arrays 402A-402N in the storage access system 400 comprises a plurality of physical storage units as described for FIG. 3.

In accordance with at least some examples, expanders (e.g., expander 416A-416N) in the storage access system 400 are configured to expand the number of PHY layer interfaces between initiators and physical storage units in compliance with fiber optics communication protocols. Further, expanders (e.g., expander 416A-416N) in the storage access system 400 are configured to support zoning of the physical storage units described herein.

In at least some examples, the fabric 412 is in communication with the storage provisioning negotiation module 110 described herein, which may reside on and is executed by a computer system. The computer system that executes the storage provisioning negotiation module 110 may be, for example, part of a storage area network (SAN) to which the other components of storage access system 400 also belong. In operation, the storage provisioning negotiation module 110 causes its executing processor to communicate with the fabric 412 to initiate storage provisioning, to update storage provisioning, to track storage provisioning, or to perform other operations as described herein. A database (not shown) with storage pool data 220 also may couple to the fabric 412 for storage of information relevant to the operations of the storage provisioning negotiation module 110.

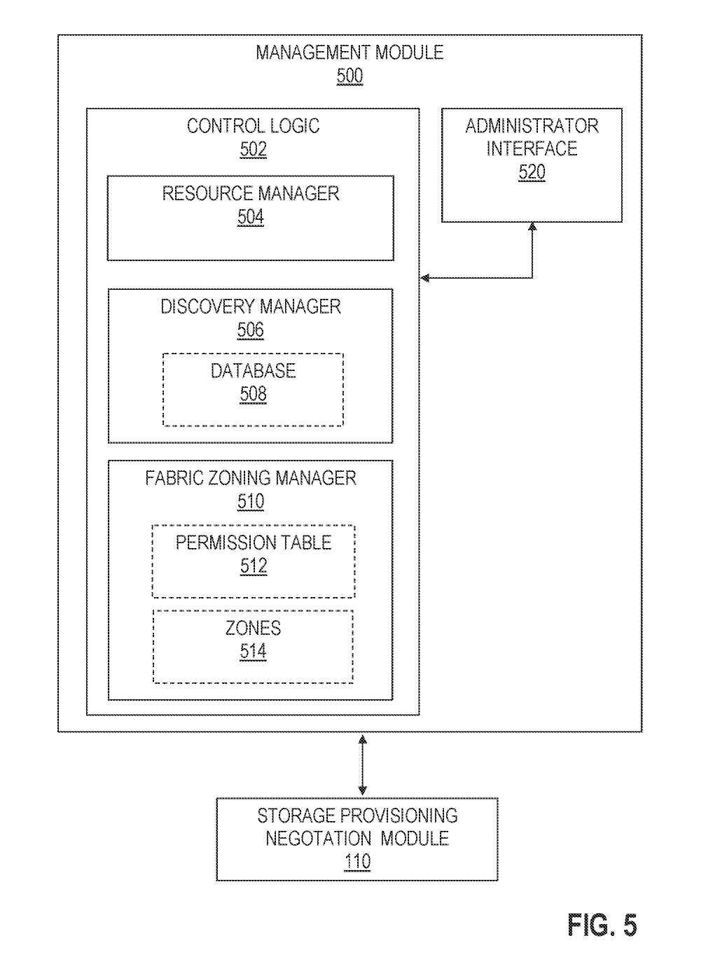

FIG. 5 shows features of a storage access system management module 500 in accordance with an example of the disclosure. The management module 500 provides various management features for a storage access system such as storage access systems 300 and 400 described herein. As shown, the management module 500 comprises control logic 502 and an administrator interface 520. More specifically, the control logic 502 comprises various components including a resource manager 504, a discovery manager 508, and a fabric zoning manager 510. The control logic components and administrator interface 520 may correspond to hardware and software that operates to perform various functions. For example, the resource manager 504, in operation, assigns communication fabric resources for a storage access system to support fixed or temporary connections between initiators and physical storage units. During an established connection between an initiator and a physical storage unit or a virtual storage unit, the resource manager 504 ensures that interruptions to active connection do not occur. In other words, even if multiple initiators have discovered and have permission to access a particular physical storage unit, the resource manager 504 ensures that overlapping storage access requests do not interfere with an established connection. Rather, overlapping storage access requests to the same physical storage unit would be handled sequentially (e.g., in the order they are received and/or according to some other prioritization criteria).

The discovery manager 506, in operation, performs discovery of all expanders and end devices (initiators and physical storage units) attached thereto. For example, the discovery manager 506 may perform discovery in response to an asynchronous event or in response to a request from a system administrator. The results of a discovery operation performed by the discovery manager 506 are stored in a database 508. In accordance with at least some examples, the database 508 may store physical storage unit addresses as well as initiator addresses and expander addresses. As needed, the database 508 is updated with each new discovery operation. Upon reception of a storage access request from an initiator, the management module 500 is able to direct the storage access request to the appropriate physical storage unit using the database 508. Similarly, a response from the physical storage unit is routed back to the initiator using the same database 508.

The fabric zoning manager 510, in operation, defines and enforces zones within a storage access system (e.g., storage access systems 300 or 400). In at least some examples, each zone of physical storage units is only discoverable and accessible to a predetermined initiator. As shown, the fabric zoning manager 510 comprises a permission table 512 and zones 514. The permission table 512 identifies zones, which define the devices (i.e., initiators and physical storage units) that communicate with each other in a fabric. An initiator or a physical storage unit can be part of multiple zones. As an example, a first initiator may be assigned to zone 1 and may have access to zones 2 and 3, while a second initiator may be in zone 4 and may have access to zone 5 and so on. Further, some zones (e.g., zones 2, 3 and 5) may identify the physical storage units associated with each zone referenced in the permission table 512.

As shown, the management module 500 may communicate with the storage provisioning negotiation module 110 described herein. In accordance with at least some examples, the resource manager 504, the discovery manager 506, the fabric zoning manager 510, and the storage provisioning negotiation module 110 operate together to support storage provisioning negotiation operations as disclosed herein. For example, in response to receiving a notification of a storage provisioning request, the storage provisioning negotiation module 110 may causes its executing processor to access information from the resource manager 504, the discovery manager 506, and/or the fabric zoning manager 510 to determine whether a storage provisioning request can be met, to identify the next-best alternatives, and to provision storage in accordance with a selected provisioning request.

Further, the storage provisioning negotiation module 110 may causes its executing processor communicate with the discovery manager 506 and the fabric zoning manager 510 to ensure that storage devices are included as desired in the database 508 and the zones 514. After a discovered physical storage unit or virtual storage unit is assigned to a zone, non-assigned initiators are not able to discover the physical storage unit or virtual storage unit. In some examples, zone assignments may be updated for discovered physical storage units and for virtual storage units in response to a control signal. Such a control signal is received by the management module 500, for example, via an administrator interface 520.

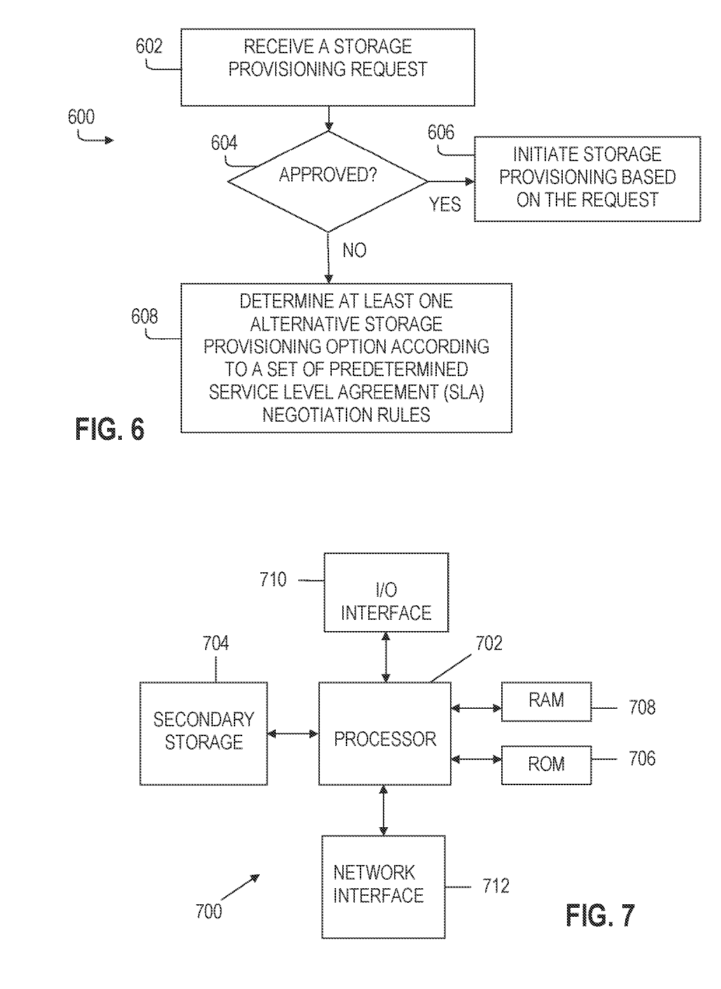

FIG. 6 shows a method 600 in accordance with various examples of the disclosure. The method 600 may be performed, for example, by processor 104 executing the storage provisioning negotiation module 110. As shown, the method 600 comprises receiving a storage provisioning request (block 602). If the storage provisioning request is approved (decision block 604), storage provisioning is initiated based on the request (block 606). Alternatively, if the storage provisioning request is not approved (decision block 604), at least one alternative storage provisioning option is determined according to a set of predetermined SLA negotiation rules (block 608).

In at least some examples, determining at least one alternative storage provisioning option as in block 608 comprises applying the predetermined SLA negotiation rules to identify an alternative storage provisioning option with a same storage tier value and a lower storage quantity value compared to the received storage provisioning request. Additionally or alternatively, determining at least one alternative storage provisioning option as in block 608 comprises applying the predetermined SLA negotiation rules to identify an alternative storage provisioning option with a lower storage tier value and a same storage quantity value compared to the received storage provisioning request. Additionally or alternatively, determining at least one alternative storage provisioning option as in block 608 comprises applying the predetermined SLA negotiation rules to identify an alternative storage provisioning option with a lower storage tier value and a lower storage quantity value compared to the received storage provisioning request. Additionally or alternatively, determining at least one alternative storage provisioning option as in block 608 comprises applying the predetermined SLA negotiation rules to identify an alternative storage provisioning option in another fabric compared to the received storage provisioning request. Additionally or alternatively, determining at least one alternative storage provisioning option as in block 608 comprises applying the predetermined SLA negotiation rules to identify a prioritized set of alternative storage provisioning options according to a storage tier criteria, a storage quantity criteria, and a storage fabric criteria.

The storage provisioning negotiation components and operations to support identification and selection of next-best storage provisioning as described herein may be implemented with any general-purpose computing component, such as an application-specific integrated chip (ASIC), a computer, or a network component with sufficient processing power, memory resources, and network throughput capability to handle the necessary workload placed upon it. FIG. 7 illustrates a typical, general-purpose computer system 700 suitable for implementing one or more examples of the components disclosed herein. The computer system 700 includes a processor 702 (which may be referred to as a central processor unit or CPU) that is in communication with memory devices including secondary storage 704, read only memory (ROM) 706, and random access memory (RAM) 708, with an input/output (I/O) interface 710, and with a network interlace 712. The processor 702 may be implemented as one or more CPU chips, or may be part of one or more application specific integrated circuits (ASICs).

The secondary storage 704 is typically comprised of one or more disk drives, flash devices, or tape drives and is used for non-volatile storage of data and as an over-flow data storage device if RAM 708 is not large enough to hold all working data. Secondary storage 704 may be used to store programs that are loaded into RAM 708 when such programs are selected for execution. The ROM 706 is used to store instructions and perhaps data that are read during program execution. ROM 706 is a non-volatile memory device that typically has a small memory capacity relative to the larger memory capacity of secondary storage 704. The RAM 708 is used to store volatile data and perhaps to store instructions. Access to both ROM 706 and RAM 708 is typically faster than to secondary storage 704.

The RAM 706, RAM 708, and/or the secondary storage 704 are examples of non-transitory computer-readable mediums that may store storage provisioning instructions correspond to the storage provisioning negotiation module 110. When executed, such instructions may cause the processor 702 to determine if a received storage provisioning request is approved. If the storage provisioning request is not approved, the instructions cause the processor 702 to provide a response to the received storage provisioning request, where the response includes at least one alternative storage provisioning option in accordance with a set of predetermined service level agreement (SLA) negotiation rules. Further, such instructions may cause the processor 702 to apply the predetermined SLA negotiation rules to a database of storage pool data to identify an alternative storage provisioning option with a same storage tier value and a lower storage quantity value compared to the received storage provisioning request. Further, such instructions may cause the processor 702 to apply the predetermined SLA negotiation rules to a database of storage pool data to identify an alternative storage provisioning option with a lower storage tier value and a same storage quantity value compared to the received storage provisioning request. Further, such instructions may cause the processor 702 to apply the predetermined SLA negotiation rules to a database of storage pool data to identify an alternative storage provisioning option with a lower storage tier value and a lower storage quantity value compared to the received storage provisioning request. Further, such instructions may cause the processor 702 to apply the predetermined SLA negotiation rules to a database of storage pool data to identify a prioritized set of alternative storage provisioning options according to a storage tier criteria, a storage quantity criteria, and a storage fabric criteria.

The above discussion is meant to be illustrative of the principles and various examples of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a processor; and
a storage device coupled to the processor, wherein the storage device stores a storage provisioning negotiation module that, when executed, causes the processor to determine whether a received storage provisioning request is approved,
wherein, if the received storage provisioning request is not approved, the storage provisioning negotiation module causes the processor to determine a set of alternative storage provisioning options based on predetermined negotiation rules.

2. The computer system of claim 1, wherein the predetermined negotiation rules comprise a rule to cause the processor to identify whether an alternative storage provisioning option is available in another fabric compared to the received storage provisioning request.

3. The computer system of claim 1, wherein the predetermined negotiation rules cause the processor to determine a set of alternative storage provisioning options according to a storage tier criteria, a storage quantity criteria, and a storage fabric criteria.

4. The computer system of claim 1, wherein the storage provisioning negotiation module causes the processor to respond to a selection of an alternative storage provisioning option by initiating storage provisioning according to the selection subject to an automated clearance check performed after said selection.

5. The computer system of claim 1, wherein the storage provisioning negotiation module causes the processor to respond to a selection of an alternative storage provisioning option by initiating storage provisioning according to the selection subject to approval based on a manual clearance check performed by an administrator after said selection.

6. The computer system of claim 1, wherein if an alternative storage provisioning option is selected and is not approved due to a clearance check failure, the storage provisioning negotiation module causes the processor to subsequently determine another set of alternative storage provisioning options based on the predetermined negotiation rules.

7. A method, comprising:
receiving, by a processor, a storage provisioning request;
determining, by the processor, whether the storage provisioning request is approved; and
if the storage provisioning request is not approved, determining, by the processor, at least one alternative storage provisioning option according to a set of predetermined service level agreement (SLA) negotiation rules.

8. The method of claim 7, wherein determining the at least one alternative storage provisioning option comprises applying the predetermined SLA negotiation rules to identify an alternative storage provisioning option with a same storage tier value and a lower storage quantity value compared to the received storage provisioning request.

9. The method of claim 7, wherein determining the at least one alternative storage provisioning option comprises applying the predetermined SLA negotiation rules to identify an alternative storage provisioning option with a lower storage tier value and a same storage quantity value compared to the received storage provisioning request.

10. The method of claim 7, wherein determining the at least one alternative storage provisioning option comprises applying the predetermined SLA negotiation rules to identify an alternative storage provisioning option with a lower storage tier value and a lower storage quantity value compared to the received storage provisioning request.

11. The method of claim 7, wherein determining the at least one alternative storage provisioning option comprises applying the predetermined SLA negotiation rules to identify a prioritized set of alternative storage provisioning options according to a storage tier criteria, a storage quantity criteria, and a storage fabric criteria.

12. A non-transitory computer-readable medium storing storage provisioning instructions that, when executed, cause a processor to:
determine if a received storage provisioning request is approved; and
if the storage provisioning request is not approved, apply predetermined service level agreement (SLA) negotiation rules to storage pool data to identify a plurality of alternative storage provisioning options; and
negotiate selection of one of the plurality of alternative storage provisioning options.

13. The non-transitory computer-readable medium of claim 12, wherein the storage provisioning instructions further cause the processor to apply the predetermined SLA negotiation rules to the storage pool data to:
identify at least one alternative storage provisioning option with a same storage tier value and a lower storage quantity value compared to the received storage provisioning request;
identify at least one alternative storage provisioning option with a lower storage tier value and a same storage quantity value compared to the received storage provisioning request; and
identify at least one alternative storage provisioning option with a lower storage tier value and a lower storage quantity value compared to the received storage provisioning request

14. The non-transitory computer-readable medium of claim 12, wherein the storage provisioning instructions further cause the processor to provision a selected option and to submit the selected option to a clearance check prior to being provisioned.

15. The non-transitory computer-readable medium of claim 12, wherein the storage provisioning instructions further cause the processor to apply the predetermined SLA negotiation rules to a database of storage pool data to identify a prioritized set of alternative storage provisioning options according to a storage tier criteria, a storage quantity criteria, and a storage fabric criteria.
